(19) United States
(12) Patent Application Publication
(10) Pub. No.: US 2012/0277006 A1
(43) Pub. Date: Nov. 1, 2012

(54) APPARATUS FOR DISCONNECTING TRANSMISSION OF POWER IN CLUTCHLESS ASSEMBLY

(76) Inventor: Bae Kyeong KIM, Daegu (KR)

(21) Appl. No.: 13/440,598

(22) Filed: Apr. 5, 2012

(30) Foreign Application Priority Data
Apr. 26, 2011 (KR) 2011-0039057

(51) Int. Cl. F16D 7/00

(52) U.S. Cl. 464/37

(57) ABSTRACT

An apparatus in a clutchless assembly, which connects or disconnects the transmission of rotational power when an overload equal to or greater than a limit torque occurs in an air conditioner. A rotor 10 is connected to a rotary shaft of an internal combustion engine via a chain or a belt to receive rotational power supplied from the internal combustion engine. A transmitting member 30 is connected to the rotor 10 via a medium 20 to transmit the rotational power to an air conditioner. A plurality of elastic members 40 is interposed between the rotor 10 and the transmitting member 30. When an overload equal to or greater than a limit torque is applied to the air conditioner, the plurality of elastic members 40 disconnects the transmission of the rotational power to the rotor 10. The transmission of power is disconnected without damage to components@ or surrounding components.

### CROSS REFERENCE TO RELATED APPLICATION

The present application claims priority from Korean Patent Application Number 10-2011-39057 filed on Apr. 26, 2011, the entire contents of which application are incorporated herein for all purposes by this reference.

### BACKGROUND OF THE INVENTION

1. Field of the Invention

The present invention relates to a clutchless assembly, which connects or disconnects the transmission of rotational power when an overload equal to or greater than a limit torque occurs in an air conditioner or the like, and more particularly, to an apparatus for disconnecting the transmission of power in a clutchless assembly, in which a non-destructive mechanism is applied such that the apparatus can be reused even if the power transmission line of the clutchless assembly is disconnected.

2. Description of Related Art

In general, a clutchless assembly is a device that transmits rotational power generated from an internal combustion engine or a drive motor to an air conditioner. The clutchless assembly is provided on a power transmission line between the internal combustion engine and the air conditioner, and performs a dual function of transmitting or disconnecting power that is to be supplied to the air conditioner.

That is, the clutchless assembly normally operates to connect the internal combustion engine and the air conditioner. When the air conditioner is subjected to an overload equal to or greater than a limit torque due to an abnormality, the clutchless assembly disconnects the power transmission line in order to protect surrounding devices, including the belt of the internal combustion engine.

In particular, the belt of the internal combustion engine is connected to electrical devices, such as a water pump, an alternator, or a coolant pump. Since the clutchless assembly selectively connects or disconnects the power transmission line, it is possible to protect the belt, and thus protect the surrounding devices, thereby enabling safe driving, even if the pulley of the air conditioner stops.

Therefore, devices for connecting or disconnecting the power transmission line of the internal combustion engine have been proposed. In particular, destructive types, in which a connector member is destroyed when an overload equal to or greater than a limit torque is applied to the air conditioner or the like, have mainly been studied.

For example, as shown in FIG. 1, the clutchless assembly includes a front housing 2, a rotary shaft 4, which is mounted on the central portion of the front housing 2, a pulley 6, which is mounted on the outer circumference of the front housing 2 via an angular bearing 5 such that a belt 7 is abutted against the outer circumference thereof, and a transmitting member 8, which is fastened to the rotary shaft 4 via a lock nut 9 and to the pulley 6 via a number of leaf springs 10.

Accordingly, when the rotational power generated by the internal combustion engine is transmitted to the pulley 6 via the belt 7, the power generated by the internal combustion engine is transmitted to the air conditioner via the pulley 6 and the transmission body 8, so that the air conditioner can operate without a separate power source.

On the other hand, when an overload equal to or greater than the limit torque is applied due to the occurrence of an abnormality on the power transmission line of the clutchless assembly, the leaf springs 10 are destroyed in order to disconnect the power transmission line, so that the rotational power from the internal combustion engine is not transmitted to the air conditioner anymore, thereby preventing damage due to overloading.

In the clutchless assembly, respective ends of each leaf spring 12 are riveted to the pulley 6 and to the transmitting member 8. When an overload equal to or greater than a limit torque is applied to the power transmission line, the leaf spring 10 must be destroyed, thereby making it impossible to reuse the clutch.

When an overload capable of destroying the lead spring 10 is applied to the power transmission line, both ends of the leaf spring 10 damage surrounding components, such as the pulley 6 or the transmitting member 8, to which they were riveted. Therefore, it becomes impossible to reuse the clutchless assembly becomes impossible, thereby decreasing the longevity thereof.

Accordingly, when the leaf spring 10 is destroyed due to the application of an overload equal to or greater than a limit torque to the clutchless assembly, the process of replacing the entire clutchless assembly increases the time and burden of repair work. In addition, due to the replacement of the surrounding components, including the clutchless assembly, the burden and cost of work are further increased.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide an apparatus for disconnecting the transmission of power in a clutchless assembly, in which a non-destructive mechanism is applied such that the apparatus can be reused and surrounding components can be prevented from being damaged even if a power transmission line of the clutchless assembly is disconnected.

In an aspect of the present invention, provided is an apparatus for disconnecting the transmission of power in a clutchless assembly. The apparatus includes a rotor connected to a rotary shaft of an internal combustion engine via a chain or a belt, the rotor receiving rotational power supplied from the internal combustion engine; a transmitting member connected to the rotor via a medium, the transmitting member transmitting the rotational power to an air conditioner; and a plurality of elastic members interposed between the rotor and the transmitting member. When an overload equal to or greater than a limit torque is applied to the air conditioner, the plurality of elastic members disconnects the transmission of the rotational power to the rotor. Each elastic member includes a coupling-hole, which is coupled to one of the rotor and the transmitting member via a fixing rivet, and a coupling recess, which is coupled to the other one of the rotor and the transmitting member via a holding rivet. Each elastic member also includes a dislodging section, which maintains the state in which the holding rivet is coupled to the coupling recess.

According to embodiments of the invention, first, when a load equal to or greater than a limit torque is applied to the air conditioner, a power transmission line can be disconnected due to the separation of the elastic members from each other, thereby disconnecting the transmission of power without damage to the assembly or secondary damage to surrounding components.

Second, the elastic members can be reused even if a load equal to or greater than a limit torque is applied. This can increase the longevity of the clutchless assembly and reduce the burden of work and incidental expenses caused by maintenance.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is an assembled cross-sectional view showing a clutchless assembly of the related art;

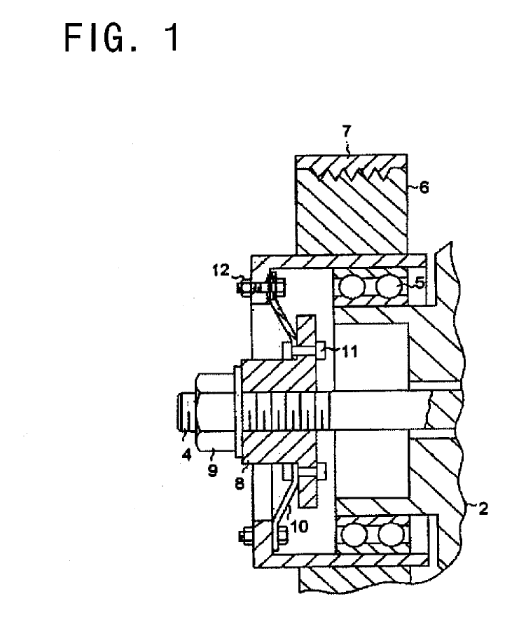

FIG. 2 is an assembled cross-sectional view showing a clutchless assembly according to the invention;

FIG. 3 is an exploded perspective view showing an embodiment of the clutchless assembly according to the invention;

FIG. 4 is cross-sectional views showing the operation of the clutchless assembly shown in FIG. 3;

FIG. 5 is an exploded perspective view showing another embodiment of the clutchless assembly according to the invention; and

FIG. 6 is an assembled perspective view showing the apparatus for disconnecting the transmission of power in the clutchless assembly according to the invention.

### DETAILED DESCRIPTION OF THE INVENTION

Reference will now be made in detail to various embodiments of the present invention, examples of which are illustrated in the accompanying drawings and described below. While the invention will be described in conjunction with exemplary embodiments thereof, it is to be understood that the present description is not intended to limit the invention to those exemplary embodiments. On the contrary, the invention is intended to cover not only the exemplary embodiments, but also various alternatives, modifications, equivalents and other embodiments that may be included within the spirit and scope of the invention as defined by the appended claims.

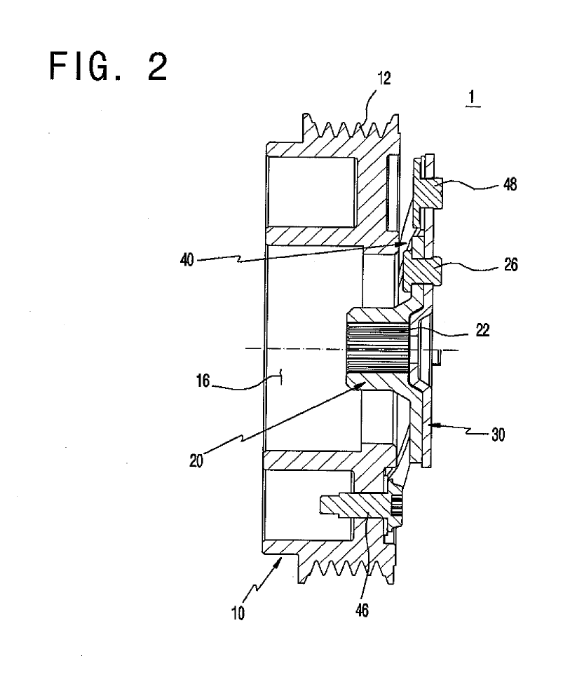

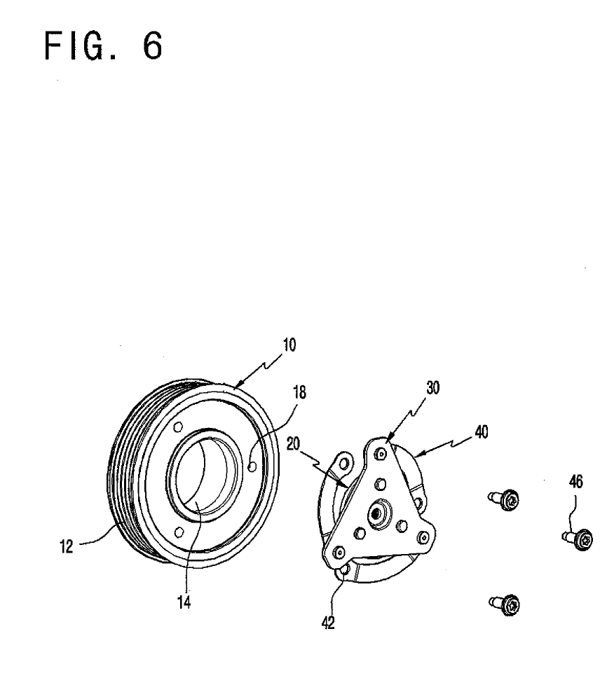

Referring to FIG. 2 to FIG. 6, according to an embodiment of the invention, an apparatus for disconnecting the transmission of power in a clutchless assembly includes a rotor 10, a transmitting member 30, and a plurality of elastic members 40. The rotor 10 is connected to the rotary shaft of an internal combustion engine via a chain or a belt such that it receives rotational power. The transmitting member 30 is connected to the rotor 10 via a medium 20 such that it transmits the rotational power to an air conditioner. The plurality of elastic members 40 is interposed between the rotor 10 and the transmitting member 30 and, when an overload equal to or greater than a limit torque is applied to the air conditioner, disconnects the transmission of the rotational power to the rotor 10. Each elastic member 40 has a coupling-hole 42 and a coupling recess 44 on both ends thereof. The coupling-hole is coupled to one of the rotor 10 and the transmitting member 30 via a fixing rivet 46, and the coupling recess 44 is coupled to the other one of the rotor 10 and the transmitting member 30 via a holding rivet 48. Also provided is a dislodging section, which maintains the state in which the holding rivet 48 is coupled to the coupling recess 44.

First, the clutchless assembly 1 of this embodiment of the invention comprises the rotor 10, the medium 20, the transmitting member 30, and the elastic members 40, which are coupled together. In particular, when an overload equal to or greater than a limit torque is applied to the air conditioner, the elastic members 40 are detached, thereby releasing a power transmission line.

Here, descriptions of the operational structure and arrangement of the internal combustion engine, which provides the rotational power to the clutchless assembly 1, the air conditioner, to which the clutchless assembly 1 transmits the rotational power, and various electrical equipment and components will not be described in detail, since they are well-known in the art.

Since the rotor 10, the medium 20, and the transmitting member 30 can be configured so as to have a variety of shapes and coupling structures, detailed descriptions thereof are omitted. A construction in which the elastic members 40 are provided in a power transmission line that includes the rotor 10, the medium 20 and the transmitting member 30 is of course embraced by the technical scope of the invention.

Here, the rotor 10 forms the contour of the clutchless assembly 1 while supporting the entire weight of the assembly. The rotor 10 is connected to the rotary shaft of the internal combustion engine via a connecting means, such as a belt or a chain, and rotates together with the rotary shaft. The rotor 10 has a wheel on the outer circumference thereof, against which the belt or chain is abutted.

In addition, the rotor 10 has a shaft-hole 14, into the center of which the medium 20 is interference-fitted, and a storage space 16, which houses components in the inner space thereof. A plurality of fastening-holes 18 is formed in the front surface of the rotor 10, and one end of the elastic member 40, which will be described later, is coupled to one of the fastening-holes 18.

In addition, the medium 20 receives the rotational power from the rotor 10, and transmits it to the transmitting member 30. The medium 20 includes a spline shaft 22, which is inserted into the shaft-hole 14, and a contact plate 24, which is integrally formed on one shaft portion of the spline 22 and is abutted against the front surface of the rotor 10.

Here, the contact plate 24 has a number of rivet-holes 28, through which it is coupled to one surface of the transmitting member 30 via a corresponding number of rivets 26.

In addition, the transmitting member 30 receives the rotational power from the rotor 10 via the medium 20, and transmits it to the air conditioner. The transmitting member 30 has a number of rivet-holes 34 and a number of rivet-holes 32 in the body thereof. Each rivet-hole 34 is coupled to the medium 20 via a rivet 26, and one end of each elastic member 40 is coupled to each rivet-hole 32.

In addition, the plurality of elastic members 40 is interposed between the rotor 10 and the transmitting member 30, and serves to selectively transmit and disconnect the rotational power of the rotor 10. Respective ends of each elastic member 40 are hinged or fitted to the front surface of the rotor 10 and to the rear surface of the transmitting member 30.

The elastic member 40 has the coupling-hole 42, which is formed in one end thereof and is coupled to one of the transmitting member 30 via the fixing rivet 46. The coupling recess 44 is formed in the other end of the elastic member 40, and one of the rotor 10 and the transmitting member 30 is fitted to the coupling recess 44 via the holding rivet 48.

It is preferred that the fixing rivet 46 be coupled to the rotor 10 if possible, and that the holding rivet 48 be fastened to the transmitting member 30 if possible.

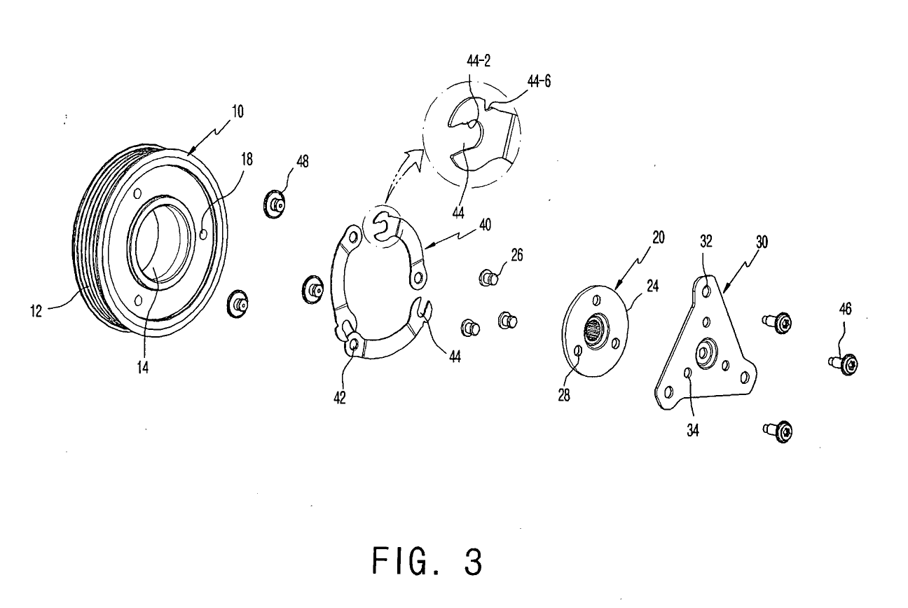

In addition, as shown in FIG. 3 to FIG. 5, the dislodging section is formed in the coupling recess 44. The dislodging section maintains the holding rivet 48 in a coupled state when an overload equal to or greater than a limit torque is not applied.

That is, as shown in FIG. 3, the dislodging section includes at least one holding protrusion 44-2 bulging from the inner circumference of the coupling recess 44, and at least one notch 44-6 formed in the outer circumference of the coupling recess 44. The holding protrusion 44-2 prevents the holding rivet 48 from being separated. The notch 44-6 provides a widening space in the process in which an overload equal to or greater than a limit torque is applied to the air conditioner.

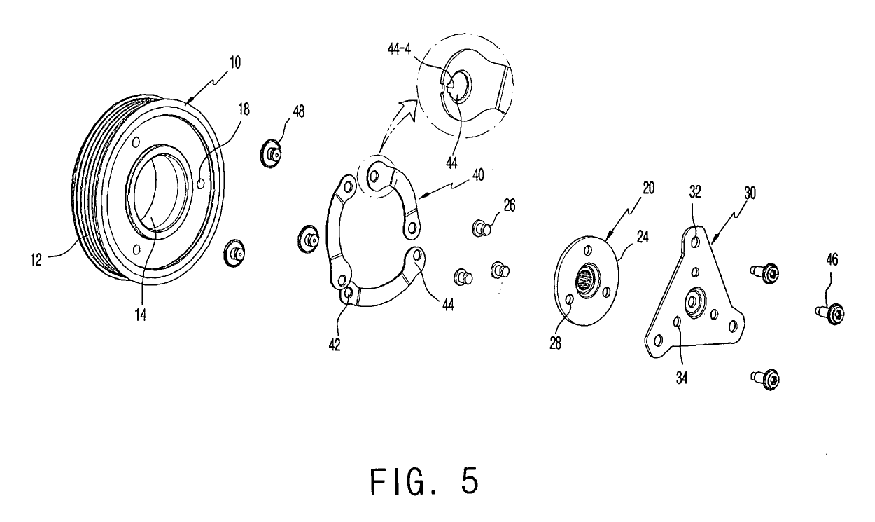

In addition, as shown in FIG. 5, the dislodging section includes a tearing piece 44-4 formed in an opening of the coupling recess 44. The tearing piece 44-4 prevents the holding rivet 48 from being dislodged, and is torn when an overload equal to or greater than a limit torque is applied to the air conditioner or the like.

Here, the width of the tearing piece 44-4 may, of course, vary depending on the capacity of the clutchless assembly.

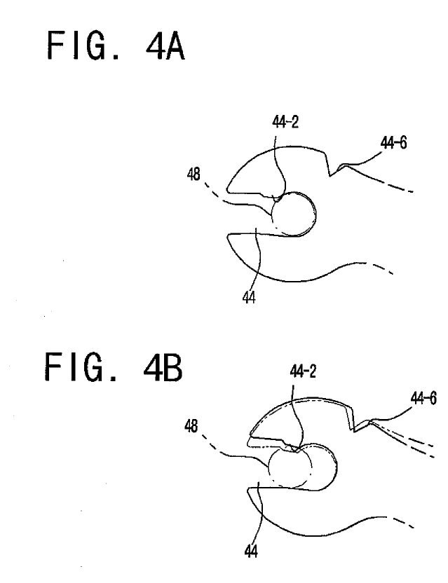

With reference to FIG. 3 and FIG. 4, a description will be given below of the operation of the invention.

First, the rotor 10 connected to the rotary shaft of the internal combustion engine via the belt or chain is rotated, causing the transmitting member 30 connected to the rotor 10 via the medium 20 and the elastic members 40 to rotate.

That is, as the rotational power generated by the rotor 10 is transmitted to the air conditioner via the medium 20, the elastic members 40 and the transmitting member 30, the surrounding parts including the air conditioner normally operate.

In particular, the rotational power generated by the rotor 10 is transmitted to the transmitting member 30 via the medium 20, since both ends of each elastic member 40 are coupled to the rotor 10 and to the transmitting member 30.

Here, the coupling-recess 44 of the elastic member 40 is elastically locked by the holding rivet 48, with the holding protrusion 44-2 holding the holding rivet 48. Therefore, in this state, the coupling-recess 44 serves to connect the components.

However, when an overload equal to or greater than a torque limit is applied to the air conditioner or the like, the coupling recess 44 is released from the holding rivet 48, to which the coupling recess 44 was coupled in the way that it is held, thereby disconnecting the power transmission line.

When a load equal to or greater than a torque limit is applied to the elastic member 40, as shown in FIG. 4B, the coupling recess 44 is widened but the notch 44-6 is shrunk, so that the elastic member 40 is decoupled from the holding rivet 48.

Of course, when the coupling recess 44 of the elastic member 40 is dislodged from the holding rivet 48, the rotational power generated by the rotor 10 is not transmitted to the transmitting member 30 via the medium 20.

Here, the elastic member 40 is in the state in which it is returning in one direction under the elastic force. Of course, since the coupling recess 44 of the elastic member 40 does not interfere with the surrounding components, the components including the elastic member 40 are not damaged.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for disconnecting transmission of power in a clutchless assembly, comprising:
a rotor connected to a rotary shaft of an internal combustion engine via a chain or a belt, the rotor receiving rotational power supplied from the internal combustion engine;
a transmitting member connected to the rotor via a medium, the transmitting member transmitting the rotational power to an air conditioner; and
a plurality of elastic members interposed between the rotor and the transmitting member, wherein, when an overload equal to or greater than a limit torque is applied to the air conditioner, the plurality of elastic members disconnects the transmission of the rotational power to the rotor,
wherein each of the elastic members comprises:
a coupling-hole, which is coupled to one of the rotor and the transmitting member via a fixing rivet;
a coupling recess, which is coupled to the other one of the rotor and the transmitting member via a holding rivet; and
a dislodging section, which maintains a state in which the holding rivet is coupled to the coupling recess.

2. The apparatus of claim 1, wherein the dislodging section comprises tearing piece formed in an opening of the coupling recess, the tearing piece bearing when an overload equal to or greater than a limit torque is applied thereto.

3. The apparatus of claim 1, wherein the dislodging section comprises a holding protrusion formed on an inner circumference of the coupling recess, the holding protrusion preventing the holding rivet from being dislodged.

4. The apparatus of claim 3, wherein the dislodging section further comprises a notch in an outer circumference of the coupling recess, the notch providing a widening space in a process in which an overload equal to or greater than a limit torque is applied to the air conditioner.
